(19) United States
(12) Patent Application Publication
(10) Pub. No.: US 2004/0023062 A1
(43) Pub. Date: Feb. 5, 2004

(54) Electroluminescent device

(75) Inventors: Poopathy Kathirgamanathan, North Harrow (GB); Seenivasagam Ravidhandran, Surrey (GB); Vijendra Kandappu, London (GB)

Correspondence Address: Dr. Marta E. Delsignore PhD, Goodwin Procter L.L.P., 599 Lexington Avenue, New York, NY, 10022, US

(73) Assignee: Elam-T Limited

(21) Appl. No.: 10/442,663

(22) Filed: May 20, 2003

Related U.S. Application Data
(63) Continuation of application No. PCT/GB01/05111, filed on Nov. 21, 2001.

(30) Foreign Application Priority Data
Nov. 21, 2000 (GB) 0028439.8

(51) Int. Cl. H05B 33/12

(52) U.S. Cl. 428/690; 428/917; 313/504; 313/506; 257/40

(57) ABSTRACT

An electroluminescent device which emits white light which comprises sequentially an anode, a layer of a hole transporting material which emits light in the blue spectrum, a layer of an organo metallic complex and a cathode.

The present invention relates to electroluminescent materials and devices incorporating electroluminescent materials.

Materials which emit light when an electric current is passed through them are well known and used in a wide range of display applications. Liquid crystal devices and devices which are based on inorganic semiconductor systems are widely used, however these suffer from the disadvantages of high energy consumption, high cost of manufacture, low quantum efficiency and the inability to make flat panel displays.

Organic polymers have been proposed as useful in electroluminescent devices, but it is not possible to obtain pure colours, they are expensive to make and have a relatively low efficiency.

Another compound which has been proposed is aluminium quinolate, but this requires dopaunts to be used to obtain a range of colours and has a relatively low efficiency.

Rare earth chelates are known which fluoresce in ultra violet radiation and A. P. Sinba (Spectroscopy of Inorganic Chemistry Vol. 2 Academic Press 1971) describes several classes of rare earth chelates with various monodentate and bidentate ligands.

Group III A metals and lanthanides and actinides with aromatic complexing agents have been described by G. Kallistratos (Chitnica Chronika, New Series, 11, 249-266 (1982)). This reference specifically discloses the Eu(III), Tb(III), U(III) and U(IV) complexes of diphenyl-phosponainidotriphenyl-phosphoran.

EP 0744451A1 also discloses fluorescent chelates of transition or lanthanide or actinide metals and the known chelates which can be used are those disclosed in the above references including those based on diketone and triketone moieties.

Any metal ion having an unfilled inner shell can be used as the metal and the preferred metals are selected from Sm(III), Eu(II), Eu(III), Tb(III), Dy(III), Yb(III), Lu(III), Gd (III), Gd(III) U(III), Tm(III), Ce (III), Pr(III), Nd(III), Pm(III), Dy(III), Ho(III) and Er(III).

Patent application WO98/58037 describes a range of lanthanide complexes which can be used in electroluminescent devices which have improved properties and give better results. Patent Applications PCT/GB98/01773, PCT/GB99/03619, PCT/GB99/04030, PCT/GB99/04024, PCT/GB99/04028, PCT/GB00/00268 describe electroluminescent complexes, structures and devices using rare earth chelates.

A typical electroluminescent device has sequentially a transparent anode such as an indium tin oxide coated glass, a layer of a hole transporting material, a layer of the electroluminescent material an electron transmitting material and a metal cathode

For many applications there is a need for electroluminescent devices which emit white light or light which appears white to the eye. Hitherto in order to achieve white light layers of electroluminescent materials which emit light in different colours which in combination appear white have been used. However this means a more complex device has to be made.

We have now devised an organometallic electroluminescent device which can emit white light and in which the colour of the light emitted can be changed by varying the field strength applied across the device,

According to the invention there is provided an electroluminescent device which comprises sequentially

(i) a first electrode

(ii) a hole transporting layer which has a component in the blue spectrum,

(iii) an electroluminescent layer incorporating (Lα)ₙM

(iv) a second electrode

where M is a rare earth metal, preferably Eu, Th, Sm or Dy and La is an organic ligands and n is the valence state of M.

Preferably M is Eu, Tb, Sm or Dy.

The preferred electroluminescent compounds which can be used in the present invention are of formula

(Lα)ₙM←Lp

where Lα and Lp are organic ligands. The ligands Lα can be the same or different and there can be a plurality of ligands Lp which can be the same or different

In this type of the ligand Lα has a negative charge and the ligand Lp is not charged.

For example (L₁)(L₂)(L₃)M (Lp) and (L₁)(L₂)(L₃) are the same or different organic complexes and (Lp) is a neutral ligand. The ligands Lp can be monodentate, bidentate or polydentate and there can be one or more ligands Lp.

Further electroluminescent compounds which can be used in the present invention are of general formula (Lα)ₙ

MM₂ where M₂ is a non rare earth metal, Lα is as above and n is the combined valence state of M and M₂. The complex can also comprise one or more neutral ligands Lp so the complex has the general formula (Lα)ₙMM₂(Lp), where Lp is as above. The metal M₂ can be any metal which is not a rare earth, transition metal, lanthanide or an actinide examples of metals which can be used include lithium, sodium, potassium, rubidium, caesium, beryllium, magnesium, calcium, strontium, barium, copper (I), copper (II), silver, gold, zinc, cadmium, boron, aluminium, gallium, indium, germanium, tin (II), tin (I), antimony (II), antimony (IV), lead (II), lead (IV) and metals of the first, second and third groups of transition metals in different valence states e.g. manganese, iron, ruthenium, osmium, cobalt, nickel, palladium(II), palladium(IV), platinum(II), platinum(IV), cadmium, chromium. titanium, vanadium, zirconium, tantalum, molybdenum, rhodium, iridium, titanium, niobium, scandium, yttrium.

Further organometallic complexes which can be used in the present invention are binuclear, trinuclear and polynuclear organometallic complexes e.g. of formula (Lm)ₓM₁←M₂(Ln)_{y} e.g.

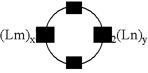

where L is a bridging ligand and where M₁ is M and M₂ is M or a non rare earth metal, Lm and Ln are the same or different organic ligands Lα as defined above, x is the valence state of M and y is the valence state of M₂.

In these complexes there can be a metal to metal bond or there can be one or more bridging ligands between M₁ and M₂ and the groups Lm and Ln can be the same or different.

By trinuclear is meant there are three metal atoms joined by a metal to metal bond i.e. of formula

(Lm)ₓM₁-M₃(Ln)_{y}-M₂(Lp)_{z}

or

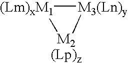

where M₁, M₂ and M₃ are M and Lm, Ln and Lp are organic ligands Lα and x, y and z are all 3. Lp can be the same as Lm and Ln or different.

The rare earth metals and the non rare earth metals can be joined together by a metal to metal bond and/or via an-intermediate bridging atom, ligand or molecular group.

For example the metals can be linked by bridging ligands e.g.

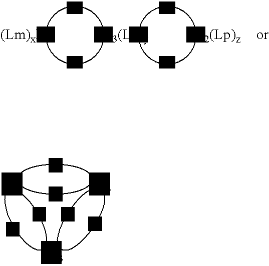

where L is a bridging ligand

By polynuclear is meant there are more than three metal atoms joined by metal to metal bonds and/or via intermediate ligands

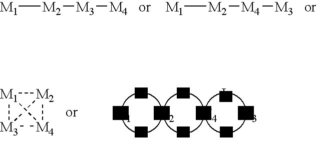

where M₁, M₂, M₃ and M₄ are M₅ and L is a bridging ligand.

Preferably Lα is selected from β diketones such as those of formulae

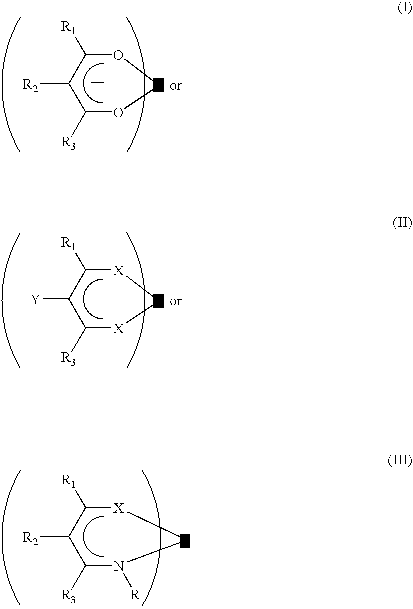

where R₁, R₂ and R₃ can be the same or different and are selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine or thiophenyl groups; R₁ R₂ and R₃ can also form substituted and unsubstituted fused aromatic, heterocyclic and polycyclic ring structures and can be copolymerisable with a monomer e.g. styrene. X is Se, S or O, Y can be hydrogen, substituted or unsubstituted hydrocarbyl groups, such as substituted and unsubstituted aromatic, heterocyclic and polycyclic ring structures, fluorine, fluorocarbons such as trifluoryl methyl groups, halogens such as fluorine or thiophenyl groups or nitrile.

Examples of R₁ and/or R₂ and/or R₃ include aliphatic, aromatic and heterocyclic alkoxy, aryloxy and carboxy groups, substituted and substituted phenyl, fluorophenyl, biphenyl, phenanthrene, antbracene, naphthyl and fluorene groups alkyl groups such as t-butyl, heterocyclic groups such as carbazole.

Some of the different groups La may also be the same or different charged groups such as carboxylate groups so that the group L₁ can be as defined above and the groups L₂, L₃ . . . can be charged groups such as

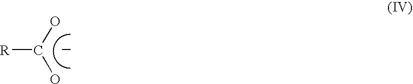

where R is R₁ as defined above or the groups L₁, L₂ can be as defined above and L₃ . . . etc. are other charged groups.

R₁, R₂ and R₃ can also be

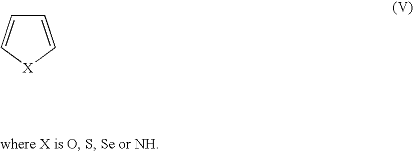

A preferred moiety R₁ is trifluoromethyl CF₃ and examples of such diketones are, banzoyltrifluoroacetone, p-chlorobenzoyltrifluoroacetone, p-bromotrifluoroacetone, p-phenyltrifluoroacetone, 1-naphthoyltrifluoroacetone, 2-naphthoyltrifluoroacetone, 2-phenathoyltrifluoroacetone, 3-phenanthoyltrifluoroacetone, 9-anthroyltrifluoroacetonetrifluoroacetone, cinnamoyltrifluoroacetone, and 2-thenoyltrifluoroacetone.

The different groups Lα may be the same or different ligands of formulae

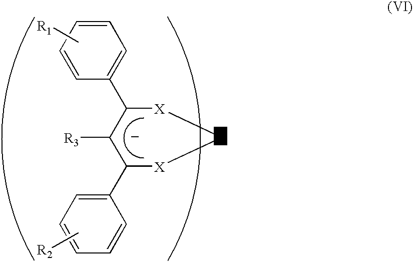

where X is O, S, or Se and R₁ R₂ and R₃ are as above

The different groups Lα may be the same or different quinolate derivatives such as

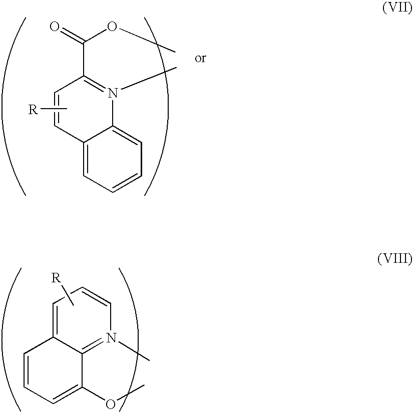

where R is hydrocarbyl, aliphatic, aromatic or heterocyclic carboxy, aryloxy, hydroxy or alkoxy e.g. the 8 hydroxy quinolate derivatives or

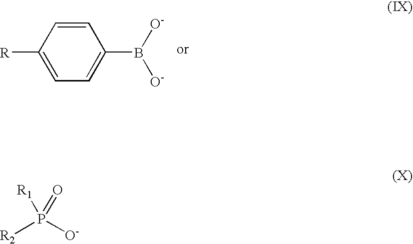

where R, R₁, and R₂ are as above or are H or F e.g. R₁ and R₂ are alkyl or alkoxy groups

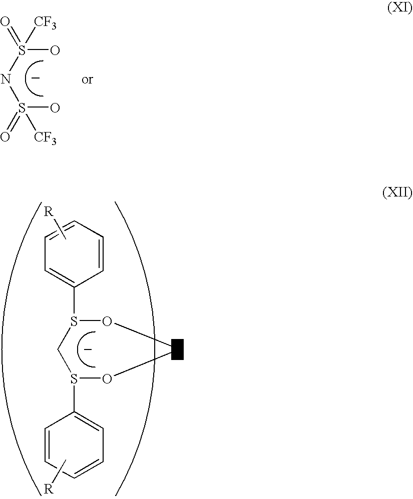

As stated above the different groups Lα may also be the same or different carboxylate groups e.g.

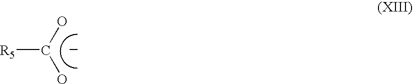

where R₅ is a substituted or unsubstituted aromatic, polycyclic or heterocyclic ring a polypyridyl group, R₅ can also be a 2-ethyl hexyl group so Lₙ is 2-ethylhexanoate or R₅ can be a chair structure so that Lₙ is 2-acetyl cyclohexanoate or Lα can be

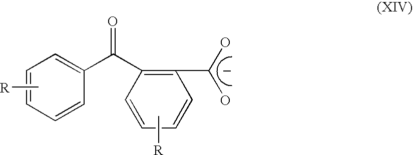

where R is as above e.g. alkyl, allenyl, amino or a fused ring such as a cyclic or polycyclic ring.

The different groups Lα may also be

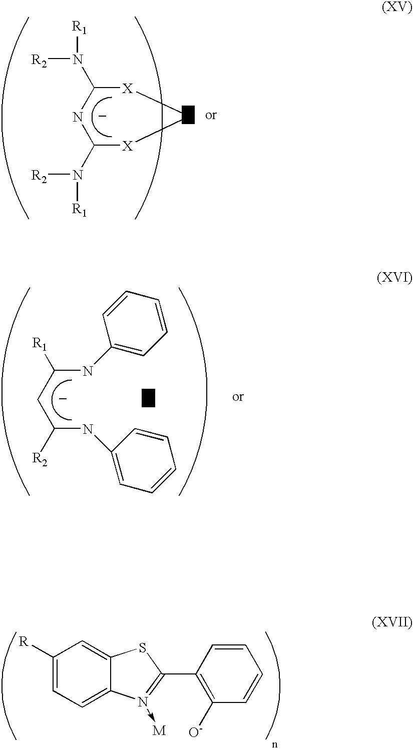

Where R, R₁ and R₂ are as above.

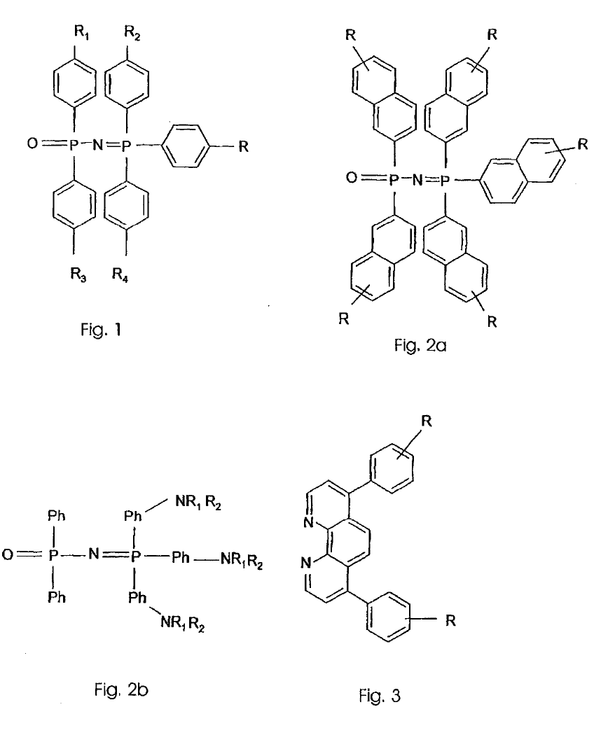

The groups Lₚ can be selected from

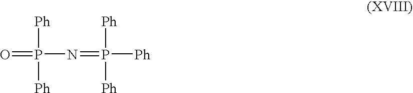

Where each Ph which can be the same or different and can be a phenyl (OPNP) or a substituted phenyl group, other substituted or unsubstituted aromatic group, a substituted or unsubstituted heterocyclic or polycyclic group, a substituted or unsubstituted fused aromatic group such as a naphthyl, anthracene, phenanthrene or pyrene group. The substituents can be for example an alkyl, aralkyl, alkoxy, aromatic, heterocyclic, polycyclic group, halogen such as fluorine, cyano, amino. Substituted amino etc. Examples are given in FIGS. 1 and 2 of the drawings where R, R₁, R₂ R₃ and R₄ can be the same or different and are selected from hydrogen, hydrocarbyl groups, substituted and unsubstituted aromatic, heterocyclic and polycyclic ring structures, fluorocarbons such as trifluoryl methyl groups, halogens such as fluorine or thiophenyl groups; R, R₁, R₂ R₃ and R₄ can also form substituted and unsubstituted fused aromatic, heterocyclic and polycyclic ring structures and can be copolymerisable with a monomer e.g. styrene. R, R₁, R₂, R₃ and 1 can also be unsaturated alkylene groups such as vinyl groups or groups

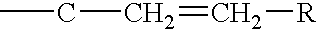

where R is as above.

Lₚ can also be compounds of formulae

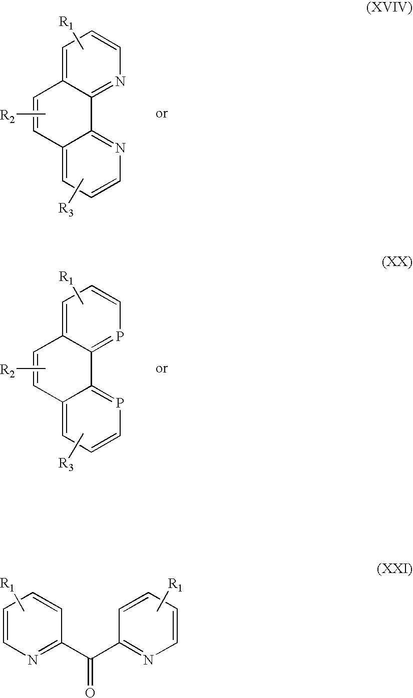

where R₁, R₂ and R₃ are as referred to above, for example bathophen shown in FIG. 3 of the drawings in which R is as above or

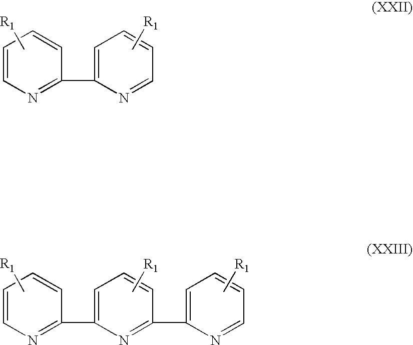

where R₁, R₂ and R₃ are as referred to above.

Lₚ can also be

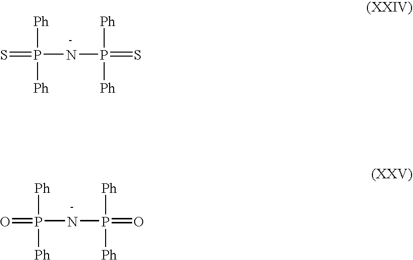

where Ph is as above.

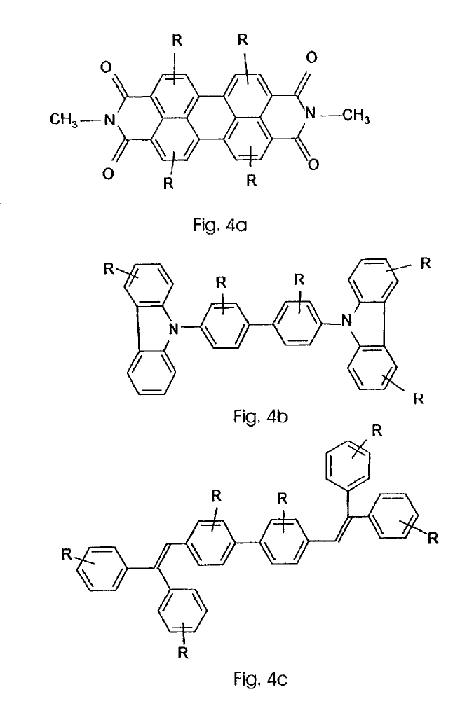

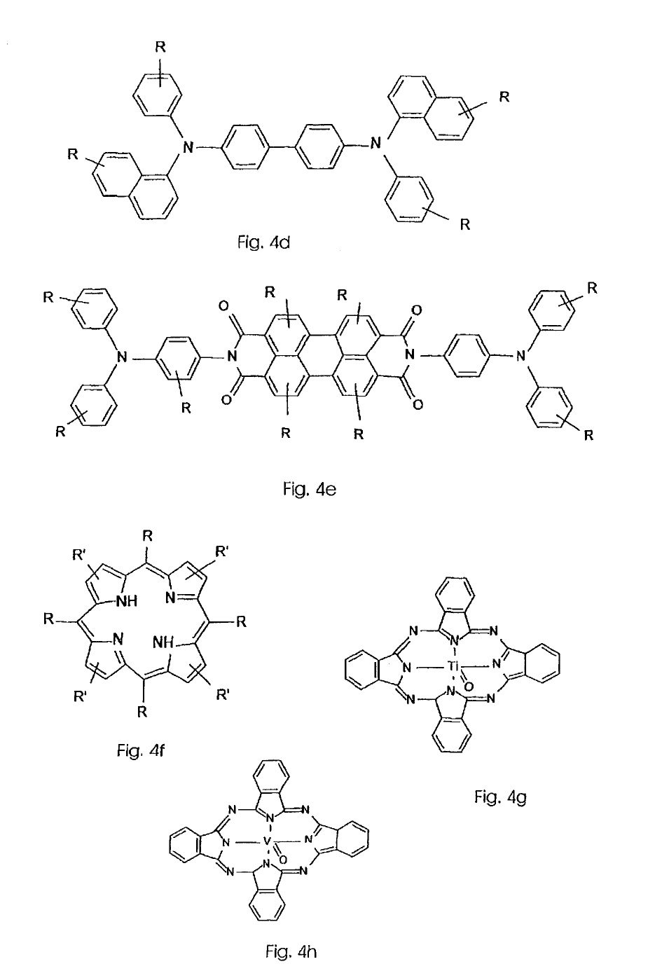

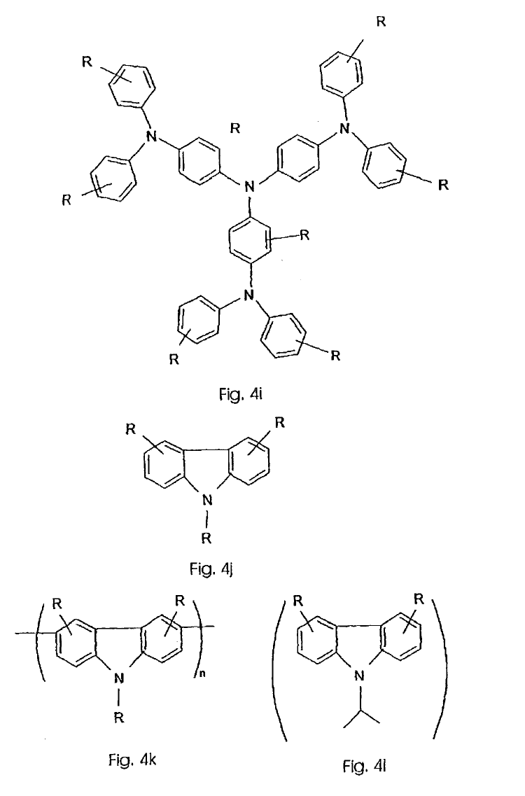

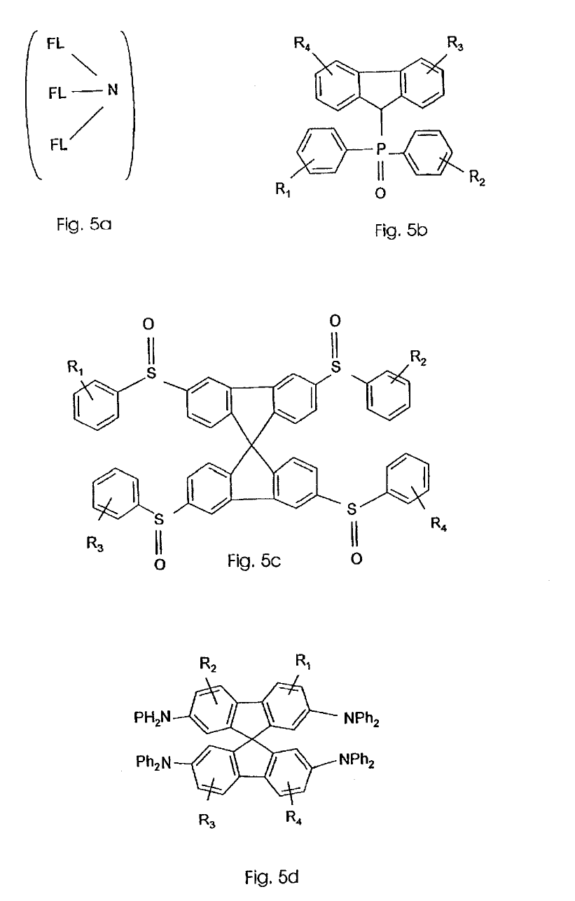

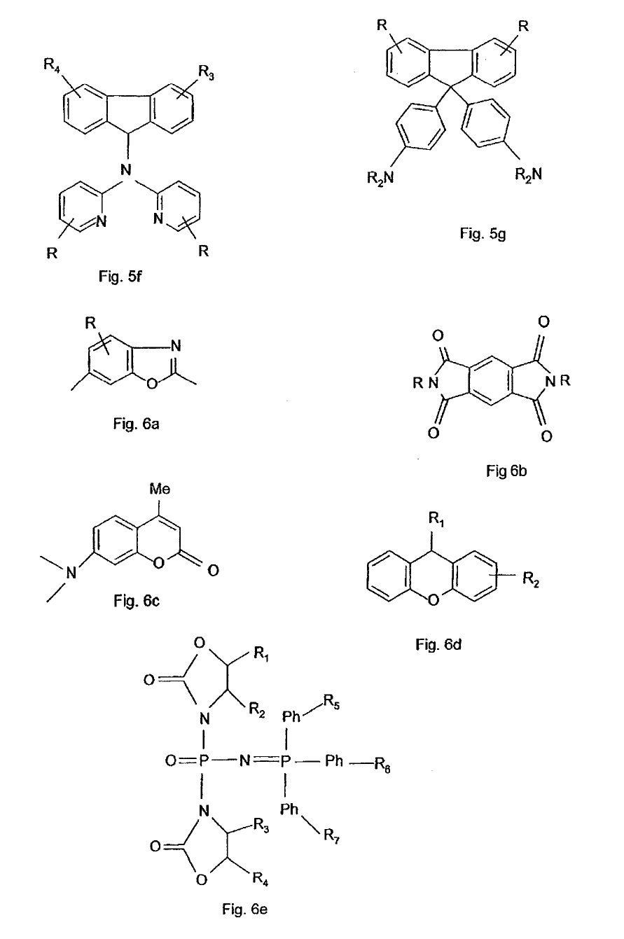

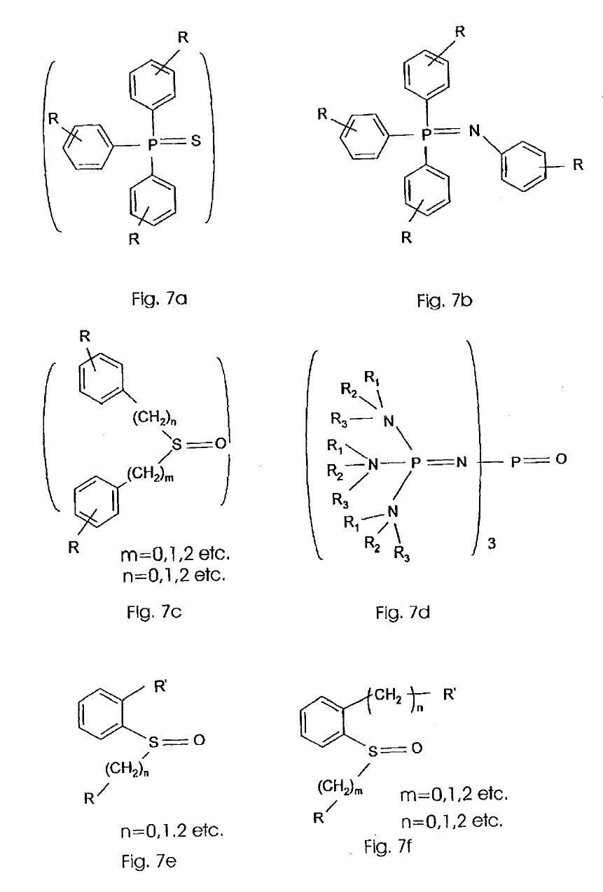

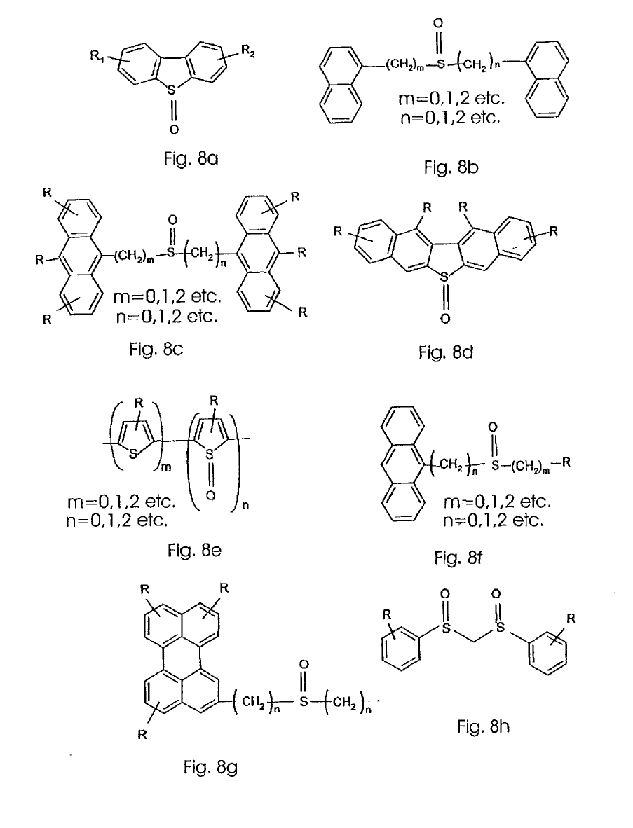

Other examples of Lₚ chelates are as shown in FIG. 4 and fluorene and fluorene derivatives e.g. a shown in FIG. 5 and compounds of formulae as shown as shown in FIGS. 6 to 8.

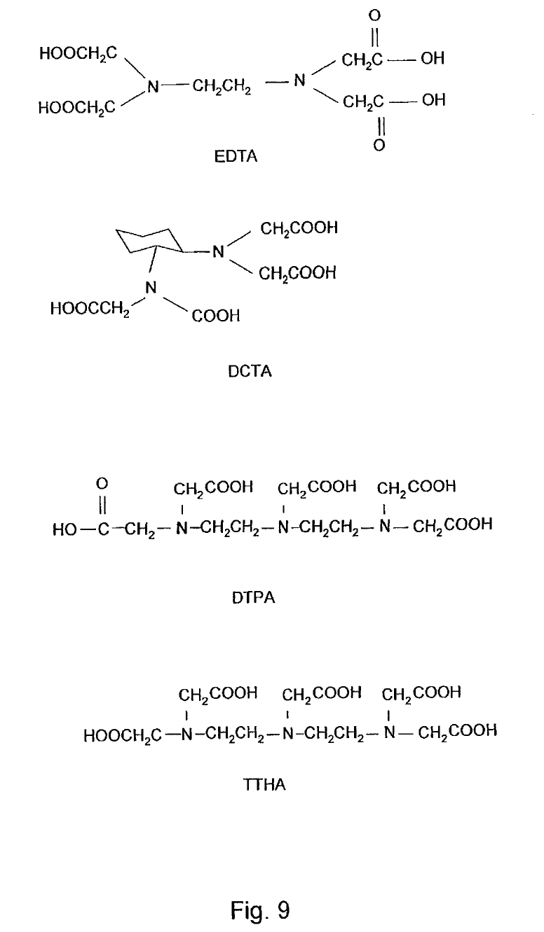

Specific examples of Lα and Lp are tripyridyl and TMHD, and TMHD complexes, α, α′, α″ tripyridyl, crown ethers, cyclans, cryptans phthalocyanans, porphoryins ethylene diamine tetramine (EDTA), DCTA, DTPA and TTHA. Where TNMD is 2,2,6,6-tetramethyl-3,5-heptanedionato and OPNP is diphenylphosphonimide triphenyl phosphorane. The formulae of the polyamines are shown in FIG. 9.

The electroluminescent material can be deposited on the substrate directly by evaporation from a solution of the material in an organic solvent. The solvent which is used will depend on the material but chlorinated hydrocarbons such as dichloromethane, n-methyl pyrrolidone, dimethyl sulphoxide, tetra hydrofuran dimethylformamide etc. are suitable in many cases.

Alternatively the material can be deposited by spin coating from solution or by vacuum deposition from the solid state e.g. by sputtering or any other conventional method can be used.

Preferred electroluminescent materials are Eu(DBM)₃OPNP, and tris (2,2,6,6-tetramethyl-3,5-heptanedionato) dysprosium (III) diphenyl phosponimido triphenylphosphorane. (TTHDyOPNP.

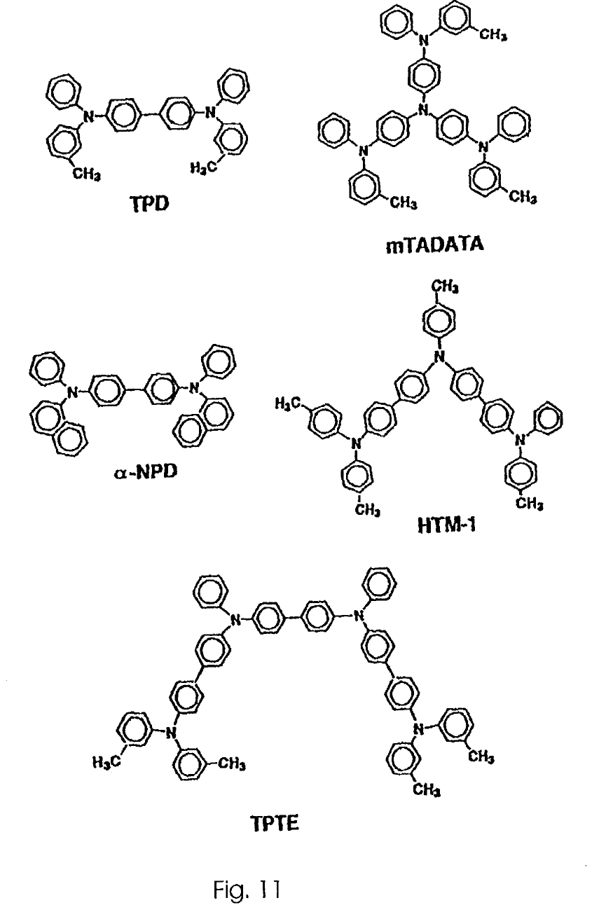

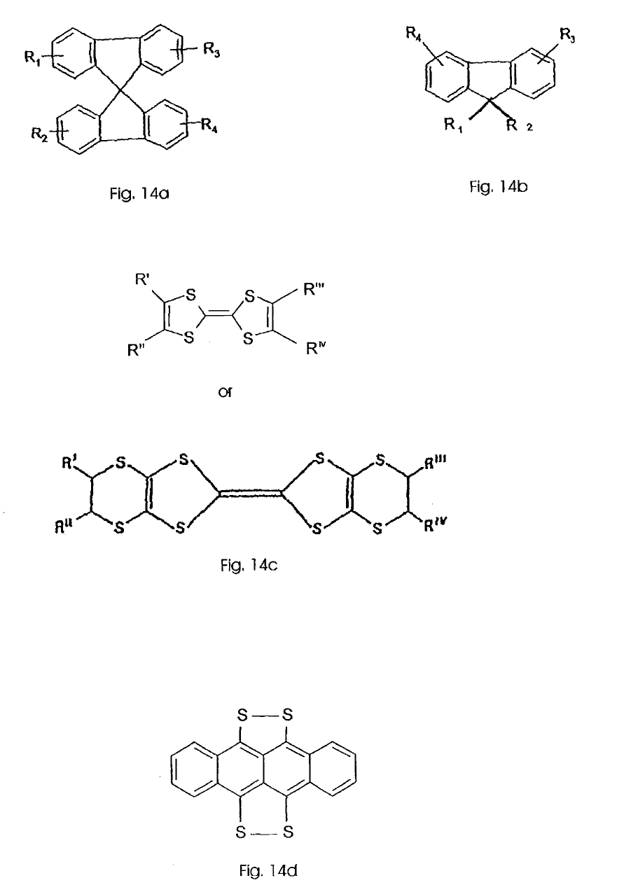

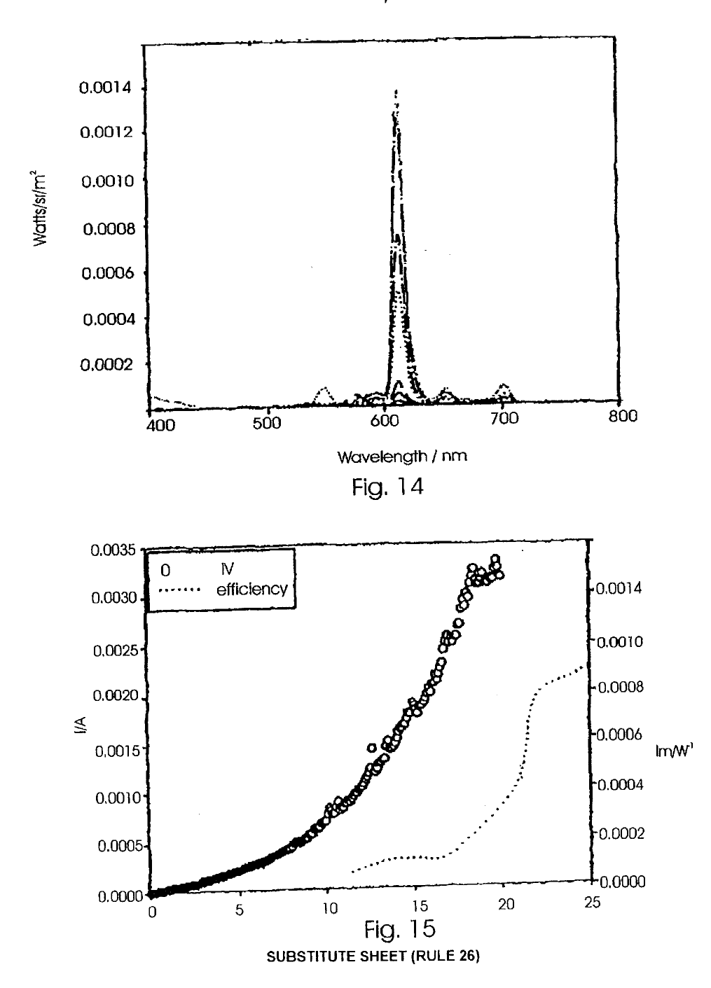

By a hole transporting layer with a component in the blue spectrum is meant a hole transporting layer which emits blue light when an electric field is applied across it. Hole transporting materials which can be used are TPD, naphthylphenyldiamine (NPD) and NPB, mTDATA which have the formula shown in FIG. 11 and compounds of formulae of FIG. 14 of the drawings and oligomers such as oligophenylenes, oligothiophenes, oligofurans.

The layer can also comprise a hole transporting layer which incorporates a blue fluorescent material so that it will emit blue light and conventional blue fluorescents can be used such as tetrathiafulvene and its analogues.

When a blue fluorescent material is used it can be mixed with known hole transporting or hole injecting materials such as the other hole transporting materials referred to below.

There can be a layer of another hole transporting material in addition to the blue emitting hole transporting materials, these include an aromatic amine complex such as poly (vinylcarbazole), N, N′-diphenyl-N,N′-bis (3-methylphenyl)-1,1′-biphenyl 4,4′-diamine (TPD), an unsubstituted or substituted polymer of an amino substituted aromatic compound, a polyaniline, substituted polyanilines, polythiophenes, substituted polythiophenes, polysilanes etc. Examples of polyanilines are polymers of

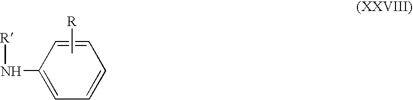

where R is in the ortho- or meta-position and is hydrogen, C1-18 alkyl, C1-6 alkoxy, amino, chloro, bromo, hydroxy or the group

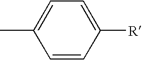

where R is alky or aryl and R′ is hydrogen, C1-6 alkyl or aryl with at least one other monomer of formula I above.

Polyanilines which can be used in the present invention have the general formula

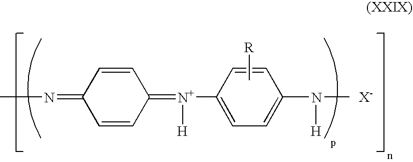

where p is from 1 to 10 and n is from 1 to 20, R is as defined above and X is an anion, preferably selected from Cl, Br, SO₄, BF₄, PF₆, H₂PO₃, H₂PO₄, arylsulphonate, arenedicarboxylate, polystyrenesulphonate, polyacrylate alkysulphonate, vinylsulphonate, vinylbenzene sulphonate, cellulosesulphonate, camphor sulphonates, cellulose sulphate or a perfluorinated polyanion.

Examples of arylsulphonates are p-toluenesulphonate, benzenesulphonate, 9,10-anthraquinone-sulphonate and anthracenesulphonate, an example of an arenedicarboxylate is phthalate and an example of arenecarboxylate is benzoate.

We have found that protonated polymers of the unsubstituted or substituted polymer of an amino substituted aromatic compound such as a polyaniline are difficult to evaporate or cannot be evaporated, however we have surprisingly found that if the unsubstituted or substituted polymer of an amino substituted aromatic compound is de-protonated it can be easily evaporated i.e. the polymer is evaporable.

Preferably evaporable de-protonated polymers of unsubstituted or substituted polymer of an amino substituted aromatic compound are used. The de-protonated unsubstituted or substituted polymer of an amino substituted aromatic compound can be formed by deprotonating the polymer by treatment with an alkali such as ammonium hydroxide or an alkali metal hydroxide such as sodium hydroxide or potassium hydroxide.

The degree of protonation can be controlled by forming a protonated polyaniline and de-protonating. Methods of preparing polyanilines are described in the article by A. G. MacDiarmid and A. F. Epstein, Faraday Discussions, Chem Soc.88 P319 1989.

The conductivity of the polyaniline is dependant on the degree of protonation with the maximum conductivity being when the degree of protonation is between 40 and 60% e.g. about 50% for example.

Preferably the polymer is substantially filly de-protonated

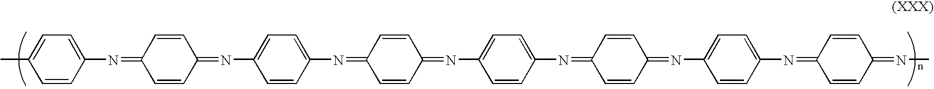

The polyanilines can have conductivities of the order of 1×10⁻¹ Siemen cm⁻¹ or higher.

The aromatic rings can be unsubstituted or substituted e.g. by a C1 to 20 alkyl group such as ethyl.

The polyaniline can be a copolymer of aniline and preferred copolymers are the copolymers of aniline with o-anisidine, m-sulphanilic acid or o-aminophenol, or o-toluidine with o-aminophenol, o-ethylaniline, o-phenylene diamine or with amino anthracenes.

Other polymers of an amino substituted aromatic compound which can be used include substituted or unsubstituted polyaminonapthalenes, polyaminoanthracenes, polyaminophenanthrenes, etc. and polymers of any other condensed polyaromatic compound. Polyaminoanthracenes and methods of making them are disclosed in U.S. Pat. No. 6,153,726. The aromatic rings can be unsubstituted or substituted e.g. by a group R as defined above.

The polyanilines can be deposited on the first electrode by conventional methods e.g. by vacuum evaporation, spin coating, chemical deposition, direct electrodeposition etc. preferably the thickness of the polyaniline layer is such that the layer is conductive and transparent and can is preferably from 20 nm to 200 nm. The polyanilines can be protonated or unprotonated, when they are protonated they can be dissolved in a solvent and deposited as a film, when they are unprotonated they are solids and can be deposited by vacuum evaporation i.e. by sublimation.

The polymers of an amino substituted aromatic compound such as polyanilines referred to above can also be used as buffer layers with other hole transporting materials.

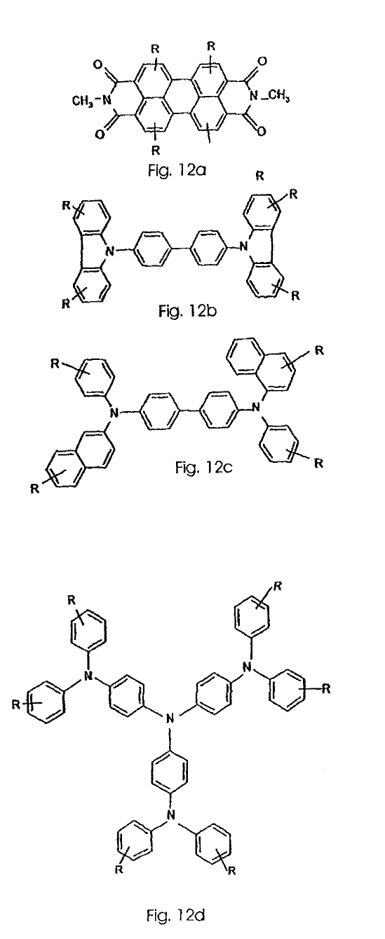

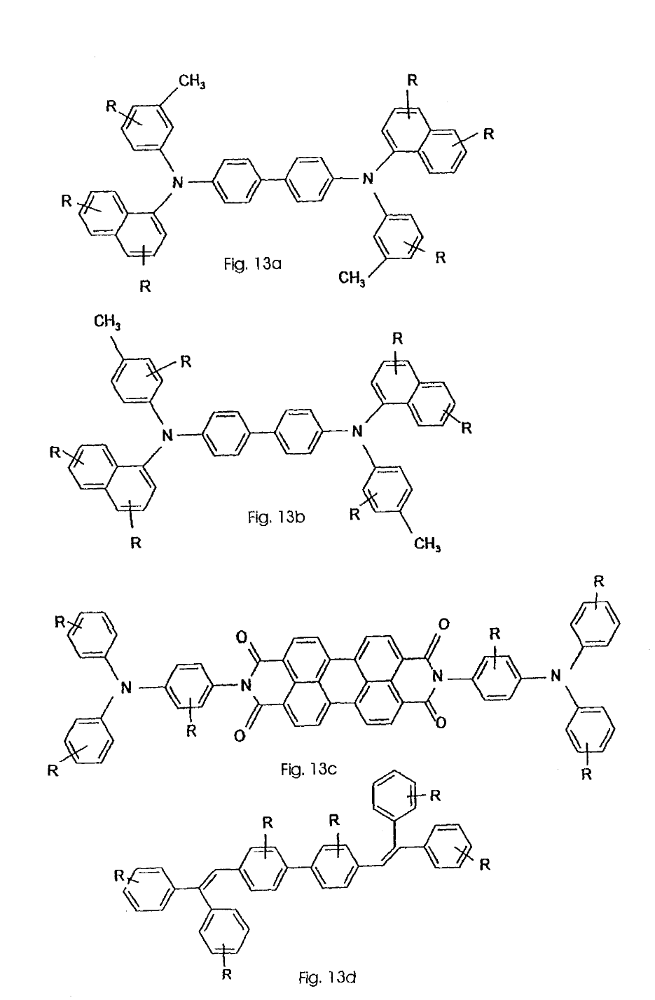

The structural formulae of some other hole transmitting materials are shown in FIGS. 11, 12, 13 and 14 of the drawings, where R₁, R₂ and R₃ can be the same or different and are selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine or thiophenyl groups; R₁, R₂ and R₃ can also form substituted and unsubstituted fused aromatic, heterocyclic and polycyclic ring structures and can be copolymerisable with a monomer e.g. styrene. X is Se, S or O, Y can be hydrogen, substituted or unsubstituted hydrocarbyl groups, such as substituted and unsubstituted aromatic, heterocyclic and polycyclic ring structures, fluorine, fluorocarbons such as trifluoryl methyl groups, halogens such as fluorine or thiophenyl groups or nitrile.

Examples of R₁ and/or R₂ and/or R₃ include aliphatic, aromatic and heterocyclic alkoxy, arytoxy and carboxy groups, substituted and substituted phenyl, fluorophenyl, biphenyl, phenanthrene, anthracene, naphthyl and fluorene groups alkyl groups such as t-butyl, heterocyclic groups such as carbazole.

Other hole transporting materials which can be used are conjugated polymers.

U.S. Pat. No. 5,807,627 discloses an electroluminescence device in which there are conjugated polymers in the electroluminescent layer. The conjugated polymers referred to are defined as polymers for which the main chain is either filly conjugated possessing extended pi molecular orbitals along the length of the chain or else is substantially conjugated, but with interruptions to conjugation, either random or regular along the main chain. They can be homopolymers or copolymers.

The conjugated polymer used can be any of the conjugated polymers disclosed or referred to in U.S. Pat. No. 5,807,627, PCT/WO90/13148 and PCT/WO92/03490.

The conjugated polymers disclosed are poly (p-phenylenevinylene)-PPV and copolymers including PPV. Other preferred polymers are poly(2,5 dialkoxyphenylene vinylene) such as poly (2-methoxy-5-(2-methoxypentyloxy-1,4-phenylene vinylene), poly(2-methoxypentyloxy)-1,4-phenylenevinylene), poly(2-methoxy-5(2-dodecyloxy-1,4-phenylenevinylene) and other poly(2,5 dialkoxyphenylenevinylenes) with at least one of the alkoxy groups being a long chain solubilising alkoxy group, poly fluorenes and oligofluorenes, polyphenylenes and oligophenylenes, polyanthracenes and oligo anthracenes, ploythiophenes and oligothiophenes.

In PPV the phenylene ring may optionally carry one or more substituents e.g. each independently selected from alkyl, preferably methyl, alkoxy, preferably methoxy or ethoxy.

Any poly(arylenevinylene) including substituted derivatives thereof can be used and the phenylene ring in poly(p-phenylenevinylene) may be replaced by a fused ring system such as anthracene or naphthlyene zing and the number of vinylene groups in each polyphenylenevinylene moeity can be increased e.g. up to 7 or higher.

The conjugated polymers which emit light in the blue spectrum can be used as the blue hole transporting layer.

The conjugated polymers can be made by the methods disclosed in U.S. Pat. No. 5,807,627, PCT/WO90/13 148 and PCT/WO92/03490.

The hole transporting material can optionally be mixed with the electroluminescent material in a ratio of 5-95% of the electroluminescent material to 95 to 5% of the hole transporting compound.

The first electrode is preferably a transparent substrate which is a conductive glass or plastic material which acts as the cathode, preferred substrates are conductive glasses such as indium tin oxide coated glass, but any glass which is conductive or has a conductive layer can be used. Conductive polymers and conductive polymer coated glass or plastics materials can also be used as the substrate. The first electrode can comprise a transparent metal such as gold, silver a platinum group metal etc.

In general the thickness of the layers is from 5 nm to 500 nm.

The second electrode functions as the cathode and can be any low work function metal e.g. aluminium, calcium, lithium, silver/magnesium alloys etc., aluminium is a preferred metal.

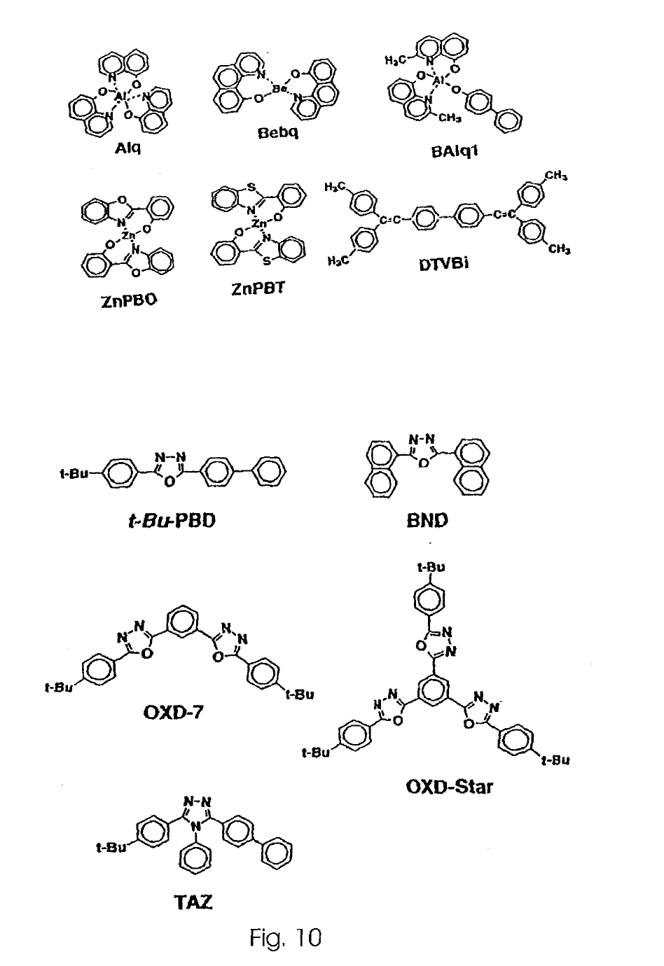

Optionally there is a layer of an electron transporting material between the second electrode, which electrode functions as the cathode, and the electroluminescent material layer, the electron transmitting material is a material which will transport electrons when an electric current is passed through electron transmitting materials include a metal complex such as a metal quinolate e.g. an aluminium quinolate, lithium quinolate a cyano anthracene such as 9,10 dicyano anthracene, a polystyrene sulphonate and compounds of formulae shown in FIG. 10. Instead of being a separate layer the electron transmitting material can be mixed with the electroluminescent material to form one layer e.g. in a proportion of 5 to 95% of the electron transmitting material to 95 to 5% of the light emitting metal compound.

The electroluminescent layer can comprise a mixture of the light emitting metal compound with the hole transporting material and electron transmitting material

The electroluminescent material can be deposited on the substrate directly by vacuum evaporation or evaporation from a solution in an organic solvent. The solvent which is used will depend on the material but chlorinated hydrocarbons such as dichloromethane and n-methyl pyrrolidone; dimethyl sulphoxide; tetra hydrofuran; dimethylformamide etc. are suitable in many cases.

Alternatively electrolumninescent material can be deposited by spin coating from solution, or by vacuum deposition from the solid state e.g. by sputtering, or any other conventional method can be used.

Preferably the first electrode is a transparent substrate such as a conductive glass or plastic material which acts as the anode, preferred substrates are conductive glasses such as indium tin oxide coated glass, but any glass which is conductive or has a transparent conductive layer such as a metal or conductive polymer can be used. Conductive polymers and conductive polymer coated glass or plastics materials can also be used as the substrate.

Either or both electrodes can be formed of silicon and the elecrolumnescent material and intervening layers of a hole transporting and electron transporting materials can be formed as pixels on the silicon substrate.

Preferably, the substrate is of crystalline silicon and the surface of the substrate may be polished or smoothed to produce a flat surface prior to the deposition of electrode, or electroluminescent compound. Alternatively a non-planarised silicon substrate can be coated with a layer of conducting polymer to provide a smooth, flat surface prior to deposition of further materials.

In one embodiment, each pixel comprises a metal electrode in contact with the substrate. Depending on the relative work functions of the metal and transparent electrodes, either may serve as the anode with the other constituting the cathode.

When the silicon substrate is the cathode an indium tin oxide coated glass can act as the anode and light is emitted through the anode. When the silicon substrate acts as the anode the cathode can be formed of a transparent electrode which has a suitable work function, for example by a indium zinc oxide coated glass in which the indium zinc oxide has a low work function. The anode can have a transparent coating of a metal formed on it to give a suitable work function. These devices arc sometimes referred to as top emitting devices or back enfitting devices.

The metal electrode may consist of a plurality of metal layers, for example a higher work function metal such as aluminium deposited on the substrate and a lower work function metal such as calcium deposited on the higher work function metal. In another example, a further layer of conducting polymer lies on top of a stable metal such as aluminium.

Preferably, the electrode also acts as a mirror behind each pixel and is either deposited on, or sunk into, the planarised surface of the substrate. However, there may alternatively be a light absorbing black layer adjacent to the substrate.

In still another embodiment, selective regions of a bottom conducting polymer layer are made non-conducting by exposure to a suitable aqueous solution allowing formation of arrays of conducting pixel pads which serve as the bottom contacts of the pixel electrodes.

As described in WO00/60669 the brightness of light emitted from each pixel is preferably controllable in an analogue manner by adjusting the voltage or current applied by the matrix circuitry or by inputting a digital signal which is converted to an analogue signal in each pixel circuit. The substrate preferably also provides data drivers, data converters and scan drivers for processing information to address the array of pixels so as to create images. When an electroluminescent material is used which emits light of a different colour depending on the applied voltage the colour of each pixel can be controlled by the matrix circuitry.

In one embodiment, each pixel is controlled by a switch comprising a voltage controlled element and a variable resistance element, both of which are conveniently formed by metal-oxide-semiconductor field effect transistors (MOSFETs) or by an active matrix transistor.

By changing the voltage the colour emitted can be changed and, as it possible to have very rapid controlled changes in voltage, this enables there to be a device which can have a very rapid change in colour in the light emitted. By a suitable construction, in which the voltage can be controlled at different locations, it is possible to have a planar device in which different colour light can be emitted at different locations and the colour of the emitted light can be varied rapidly. This enables a wide range of controlled display devices emitting different colours to be constructed.

### EXAMPLE 1

### Device Fabrication

An ITO coated glass piece (1×1 cm²) had a portion etched out with concentrated hydrochloric acid to remove the ITO and was cleaned and dried. The device was fabricated by sequentially forming on the ITO layers comprising ITO/TPD(6 mg)/Eu(DBM)₃OPNP(5 mg)/Al by vacuum evaporation. Where TPD as defined herein.

The organic coating on the portion which had been etched with, the concentrated hydrochloric acid was wiped with a cotton bud.

The coated electrodes were stored in a vacuum desiccator over a molecular sieve and phosphorous pentoxide until they were loaded into a vacuum coater (Edwards, 10⁻⁶ torr) and aluminium top contacts made. The active area of the LED's was 0.08 cm2 by 0.1 Cm² the devices were then kept in a vacuum desiccator until the electroluminescence studies were performed.

The ITO electrode was always connected to the positive terminal. The current vs. voltage studies were carried out on a computer controlled Keithly 2400 source meter.

Electroluminescence spectra were recorded by means of a computer controlled charge coupled device on PR650 system made by Photoresearch Inc.

The voltage was increased and the colour emitted noted, the colours are measured in accordance with the co-ordinates in the colour chart CIE 1931. The results are shown in the graph of FIGS. 14 and 15 and the colour coordinates and field strength shown in Table 1.

TABLE 1
ITO/TPD(6mg)/Eu(DBM)₃OPNP(5mg)/Al
Colour CIE x,y

| | | |
|---|---|---|
| 1. | 0.55, 0.31 | 0.03 cd/m² @11.5 V & 0.99 mA |
| 2. | 0.60, 0.31 | 0.09 cd/m² @14.0 V & 1.39 mA |
| 3. | 0.65, 0.33 | 0.20 cd/m² @16.5 V & 3.48 mA |
| 4. | 0.65, 0.33 | 0.46 cd/m² @18.0 V & 3.356 mA |
| 5. | 0.66, 0.34 | 1.14 cd/m² @21.0 V & 3.20 mA |
| 6. | 0.66, 0.34 | 2.28 cd/m² @22.0 V & 3.33 mA |
| 7. | 0.64, 0.34 | 3.44 cd/m² @25.0 V & 3.75 mA |
| 8. | 0.62, 0.34 | 5.81 cd/m² @28.0 V & 4.51 mA |
| 9. | 0.42, 0.44 | 5.50 cd/m² @29.0 V & 4.77 mA |

### EXAMPLE 2

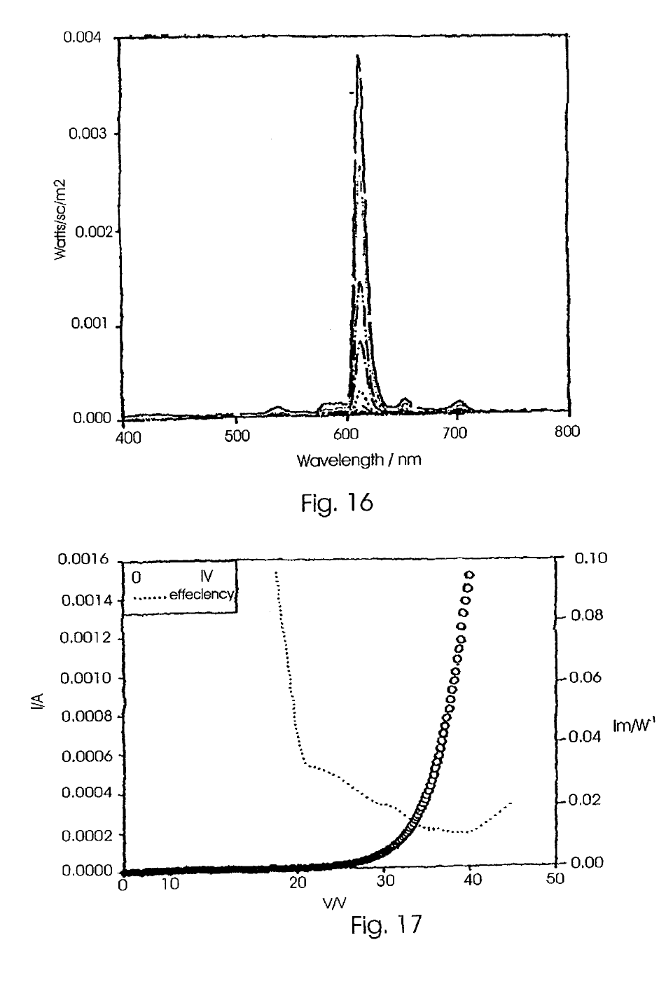

Example 1 was repeated using ITO/DFDA/(0.9 mg)/TPD(6 mg)/Eu(DBM)₃OPNP(6 mg)/Al. DFDA is diformyl diamino anthracene and TPD is as defined herein and the results illustrated in FIGS. 16 and 17 with the colour coordinates shown in Table 2

TABLE 2
Colour CIE x,y

| | | |
|---|---|---|
| 1. | 0.40, 0.33 | 0.04 cd/m² @ 17.5 V & 0.6\mathring{3} A |
| 2. | 0.61, 0.33 | 0.05 cd/m² @ 20.0 V & 1.5\mathring{3} A |
| 3. | 0.63, 0.33 | 0.15 cd/m² @ 22.5 V & 5.3\mathring{3} A |
| 4. | 0.66, 0.33 | 0.43 cd/m² @ 26.0 V & 15.7\mathring{3} A |
| 5. | 0.66, 0.34 | 1.08 cd/m² @ 29.0 V & 48\mathring{3} A |
| 6. | 0.66, 0.33 | 1.13 cd/m² @ 31.0 V & 47\mathring{3} A |
| 7. | 0.66, 0.34 | 3.47 cd/m² @ 34.0 V & 189\mathring{3} A |
| 8. | 0.65, 0.34 | 6.45 cd/m² @ 36.0 V & 357\mathring{3} A |
| 9. | 0.64, 0.34 | 12.1 cd/m² @ 40.0 V & 6651\mathring{3} A |

### EXAMPLE 3

### Preparation of Tris (2,2,6,6-tetramethyl-3,5-heptanedionato) dysprosium (III) Diphenyl Phosponimido Triphenyl Phoshorane. (TTHD)yOPNP)

Tris (2,2,6,6-tetramethyl-3,5-heptanedionato) dysprosium (III) (61 g, 19.5 mmole) and diphenyl phosponimido triphenylphosphorane. (4.6 g, 9.5 mmole) were refluxed in trimethylpentane (60 ml) for 30 minutes. The reaction mixture was the allowed to cool to room temperaure. A white crystalline material formed on standing. This was recrystallised from diethyl ether to give tris (2,2,6,6-tetramethyl-3,5-heptanedionato) dysprosium (III) diphenyl phosponimido triphenylphosphorane yield: 8 gm., mpt. 154° C.)

### EXAMPLE 4

### Device Fabrication

An ITO coated glass piece (1×10 cm²) had a portion etched out with concentrated hydrochloric acid to remove the ITO and was cleaned and dried. The device was fabricated by sequentially forming on the ITO, by vacuum evaporation, layers comprising:—

ITO/DFDAA (5 nm)/mMTDATA(30 nm)/TTHDyOPNP (55 nm)/LiF (0.7 nm)/Al(105 nm)

Where ITO is indium titanium oxide coated glass MMTDATA and DFDAA are as defined herein.

The organic coating on the portion which had been etched with the concentrated hydrochloric acid was wiped with a cotton bud. The coated electrodes were stored in a vacuum desiccator over a molecular sieve and phosphorous pentoxide until they were loaded into a vacuum coater (Edwards, 10⁻6 torr) and aluminum top contacts made. The active area of the LED's was 0.08 cm by 0.1 cm² the devices were then kept in a vacuum desiccator until the electroluminescence studies were performed.

The ITO electrode was always connected to the positive terminal The current vs. voltage studies were carried out on a computer controlled Keithly 2400 source meter.

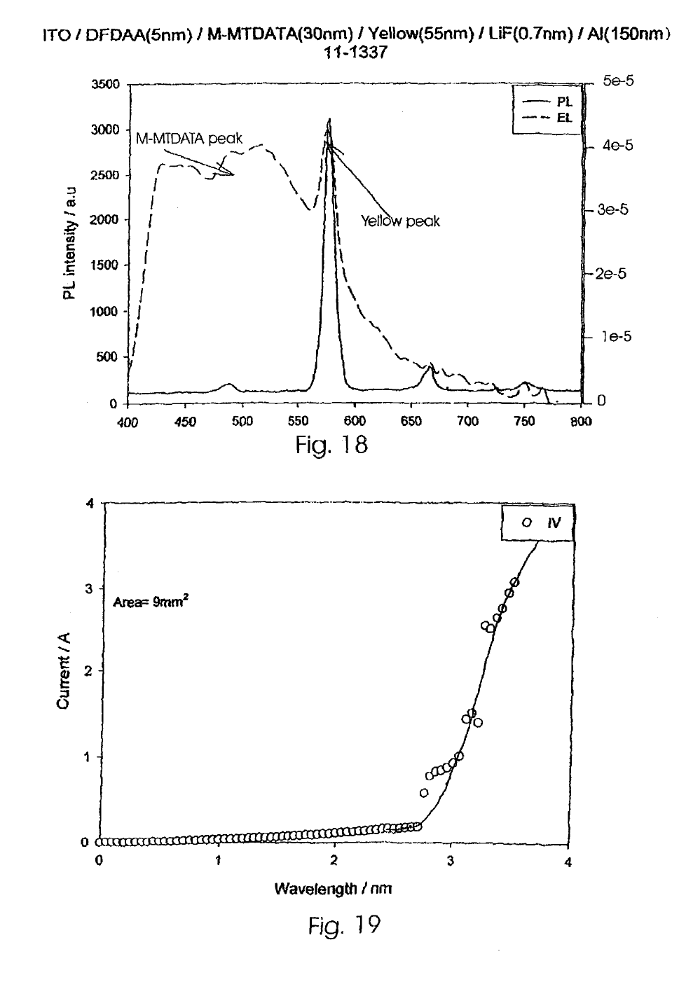

An electric current was applied across the device and the spectrum shown in FIG. 18 is a plot of the current versus wavelength is shown in FIG. 19.

1. An electroluminescent device which comprises sequentially
(i) a first electrode
(ii) a hole transporting layer which has a component in the blue spectrum,
(iii) an electroluminescent layer incorporating M(Lα)ₙ a second electrode where M, is a rare earth metal and (Lα) is an organic ligand.

2. An electroluminescent device as claimed in claim 1 in which the electrolumninescent layer incorporates a compound of formula
(Lα)ₙM←Lp
where Lα and Lp are organic ligands, the ligands Lα can be the same or different and there can be a plurality of ligands Lp which can be the same or different.

3. An electroluminescent device as claimed in claim 2 in which the electroluminescent compound is a complex of formula (L₁)(L₂)(L₃)M (Lp) and (L₁)(L₂)(L₃) are the same or different organic complexes Lα and (Lp) is a neutral ligand.

4. An electroluminescent device as claimed in claim 2 in which the electroluminescent compound is a complex of formula (Lα)ₙMM₂ where M₂ is a non rare earth metal, Lα is a as above and n is the combined valence state of M and M₂.

5. An electroluminescent device as claimed in claim 2 in which the electroluminescent compound is a complex of formula (Lα)ₙMM₂(Lp), where Lp is as above and the metal M₂ is any metal which is not a rare earth, transition metal, lanthanide or an actinide.

6. An electrolumninescent device as claimed in claim 2 in which the electroluminescent compound is a metal complex of formula 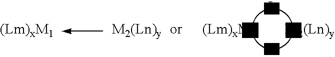
where L is a bridging ligand and where M₁ is M and M₂ is M or a non rare earth metal, Lm and Ln are the same or different organic ligands Lα as defined above, x is the valence state of M and y is the valence state of M₂ or of formula 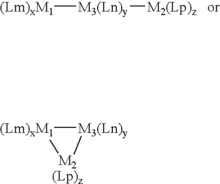
where M₁, M₂ and M₃ are M and Lm, Ln and Lp are organic ligands Lα and x, y and z are all 3, Lp can be the same as Lm and Ln or different and the rare earth metals and the non rare earth metals are joined together by a metal to metal bond and/or via an intermediate bridging atom, ligand or of formula 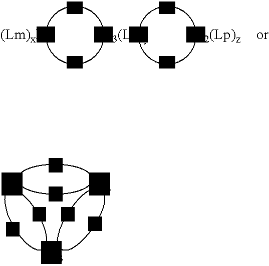
where L is a bridging ligand or of formula 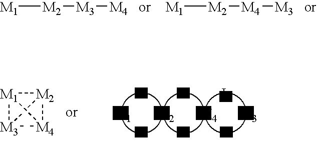
where M₁, M₂, M₃ and M are M and L is a bridging ligand.

7. An electroluminescent device as claimed in any one of claims 1 to 6 in which La has a formula of (I) to (XVII) herein.

8. An electroluminescent device as claimed in any one of claims 1 to 7 in which Lp has a formula of (VI) to (XV) or as in FIGS. 1 to 8 herein.

9. An electroluminescent device as claimed in any one of claims 1 to 8 in which the hole transporting material is mTDATA, TPD, NPD, NPV, as herein defined or has a formula as set out in FIGS. 11, 12 or 13

10. An electroluminescent device as claimed in any one of claims 1 to 9 in which M is Eu, Tb, Sm or Dy

11. An electroluminescent device as claimed in any one of claims 1 to 10 in which the hole transporting layer incorporates a blue fluorescent.

12. An electroluminescent device as claimed in any one of claims 1 to 11 in which the thickness of the hole transporting layer is greater than 5 nm.

13. An electroluminescent device as claimed in claim 12 in which the thickness of the hole transporting layer is from 10 to 50 nm.

14. An electroluminescent device as claimed in any one of claims 1 to 13 in which the thickness of the electroluminescent layer is greater than 5 nm

15. An electroluminescent device as claimed in any one of claims 1 to 14 in which the thickness of the electroluminescent layer is from 10 to 40 nm.

16. An electroluminescent device as claimed in any one of the preceding claims in which the second electrode is aluminium, calcium, lithium, or a silver/magnesium alloy.

17. An electroluminescent device as claimed in any one of the preceding claims in which there is another organic hole transporting layer in contact with the layer of light emitting material.

18. An electroluminescent device as claimed in any one of claims 1 to 17 in which the hole transporting material is a film of a polymer selected from poly(vinylcarbazole), N,N′-diphenyl-N,N′-bis (3-methylphenyl)-1,1′-biphenyl 4,4′-diamine (TPD), unsubstituted or substituted polymer of an amino substituted aromatic compounds, polyaniline, substituted polyanilines, polythiophenes, substituted polythiophenes, polysilanes and substituted polysilanes, de-protonated unsubstituted or substituted polymers of an amino substituted aromatic compounds, de-protonated polyanilines

19. An electroluminescent device as claimed in claim 17 in which the other hole transporting material is a film of a compound selected from poly(vinylcarbazole), N,N′-diphenyl-N,N′-bis (3-methylphenyl)-1,1′-biphenyl-4,4′-diamine (TPD), unsubstituted or substituted polymer of an amino substituted aromatic compounds, polyaniline, substituted polyanilines, polythiophenes, substituted polythiophenes, polysilanes and substituted polysilanes, de-protonated unsubstituted or substituted polymers of an amino substituted aromatic compounds, de-protonated polyanilines of formula (XXI) or (XXX) herein or as in FIG. 11, 12, 13, or 14 of the drawings or is a conjugated polymer.

20. An electroluminescent device as claimed in any one of claims 1 to 19 in which a hole transporting material and the light emitting metal compound are mixed to form one layer.

21 A device as claimed in any one of claims 1 to 20 in which there is a layer of an electron transmitting material between the second electrode and the layer of the electroluminescent complex

22. An electroluminescent device as claimed in claim 21 in which the electron transmitting material is a metal quinolate or as in FIG. 10 of the drawings.

23. An electroluminescent device as claimed in claim 22 in which the electron transmitting material is lithium quinolate.

24. An electroluminescent device as claimed in any one of claims 21 to 23 in which an electron transmitting material and the light emitting metal compound are mixed to form one layer.

25. An electroluminescent device as claimed in any one of the preceding claims in which the second electrode is selected from aluminium, calcium, lithium, and silver/magnesium alloys.
